(19) United States
(12) Patent Application Publication
(10) Pub. No.: US 2005/0247198 A1
(43) Pub. Date: Nov. 10, 2005

(54) Method and apparatus for removing gas bubbles from a liquid

(76) Inventor: Fraser Charles Kent, Milton (CA)

Correspondence Address: BERESKIN AND PARR, 40 KING STREET WEST, BOX 401, TORONTO, ON, M5H 3Y2, CA

(21) Appl. No.: 11/100,597

(22) Filed: Apr. 7, 2005

Related U.S. Application Data
(60) Provisional application No. 60/568,673, filed on May 7, 2004.

(51) Int. Cl. B01D 19/00

(52) U.S. Cl. 95/241; 96/219

(57) ABSTRACT

A degassing apparatus for removing bubbles from a liquid has a treatment channel adapted to conduct a flow of liquid containing entrained bubbles, and at least one bubble removal screen in the channel and through which the flow of liquid is directed to pass. The screen is adapted to provide a contact surface to which at least a portion of the entrained bubbles adhere as the flow of liquid passes through the screen, and on which the adhered bubbles grow in size to create enlarged bubbles as the adhered bubbles merge with other entrained bubbles, and from which the enlarged bubbles break free under their buoyant force and travel in a direction different from that of the liquid flow.

This is an application claiming the benefit under 35 USC 119(e) of U.S. Application Ser. No. 60/568,673 filed May 7, 2004. Application Ser. No. 60/568,673 is incorporated herein, in its entirety, by this reference to it.

### FIELD OF THE INVENTION

The present invention relates to a method and apparatus for removing gas bubbles from a liquid.

### BACKGROUND OF THE INVENTION

When processing liquids, situations can arise in which it is desirable to remove bubbles of air and/or other gases that may be entrained in the liquid. For example, water treatment often includes one or more steps of measuring particulate concentrations or counts in the water, and the presence of bubbles in the water can generate false measurements. Removal of the bubbles from the sample water prior to particulate measurement can improve the accuracy of the results generated by the particulate measurement device.

One known method for removing bubbles from a measurement sample of water involves the use of a so-called degassing column. The degassing column contains a generally constant volume of water, having an inlet at its upper end, and an outlet at its lower end. Water flows slowly downward from the inlet towards the outlet. Bubbles in the water can travel upwards to the upper surface of the water column, against the flow of the water, under the buoyant force of the bubbles. In this way, the water flowing out of the outlet (and then to the measurement device, for example) has fewer bubbles than the water entering the degassing column.

### SUMMARY OF THE INVENTION

The inventor has observed that a conventional degassing column fails to remove sufficient amounts of bubbles of a small enough size for use in some applications. For example, a particle counter may be used to monitor the integrity of a membrane filter by measuring the particle count in the permeate stream. However, since a membrane filter may be used, for example, to remove particles on the scale of viruses, bacteria or colloids, a particle counter that registers particles in this size range must be used. Such a particle will also count the presence of bubbles of a similar size which would not be a concern in other applications. A conventional degassing column is incapable of removing sufficient quantities of such tiny bubbles because bubbles with sizes in the range of a few microns rise extremely slowly and remain entrained in a slowly moving or turbulent flow of water.

It is an object of the present invention to provide a method and apparatus for removing bubbles from liquid. It is another object of the present invention to provide a modified degassing column that removes more bubbles and bubbles of a smaller size than known degassing columns. The following summary is intended to introduce the reader to the invention. However, the following summary is not intended to define the invention which may reside in a combination or sub-combination of elements or steps described below or in other parts of this document.

The present invention provides an apparatus and method in which small bubbles entrained in a liquid flow are diverted or extracted from the flow and collected or merged into larger bubbles that can move in a direction other than the liquid flow direction so as to separate the bubbles from the liquid stream. In one embodiment, the liquid flow can be directed generally vertically downward, and the merged bubbles can travel generally upward as a result of buoyancy and the increased rise velocity of the merged bubbles.

In one aspect of the present invention, an apparatus for removing bubbles from a liquid is provided, in which the apparatus includes a generally vertical column of water with one or more bubble extraction or collection elements provided along the height of the column.

### BRIEF DESCRIPTION OF THE DRAWINGS

For a better understanding of the present invention and to show more clearly how it would be carried into effect, reference will now be made by way of example, to the accompanying drawings that show an embodiment of the present invention, and in which:

FIG. 1 is a schematic view of one embodiment of a degassing apparatus according to the present invention;

FIGS. 2a and 2b are front and side elevation views of a housing of the apparatus of FIG. 1;

FIG. 3 is a perspective view of an element of the apparatus of FIG. 1;

FIG. 4 is an enlarged view of a portion of the element of FIG. 3;

FIG. 5 is a perspective view showing a plurality of elements of the apparatus of FIG. 1 in a pre-assembled state;

FIG. 6 is a perspective view of a portion of the apparatus of FIG. 1 in use;

FIG. 7 is a photograph of test equipment used in testing the apparatus of FIG. 1 and a known degassing apparatus in parallel;

FIG. 8 is a graph showing particle count measurement results with respect to time from the test of FIG. 7;

FIG. 9 is a schematic view of another embodiment of a degassing apparatus according to the present invention; and

FIGS. 10a-10d are photographs showing various views of an alternative embodiment of the element of FIG. 3.

### DETAILED DESCRIPTION OF EMBODIMENT(S)

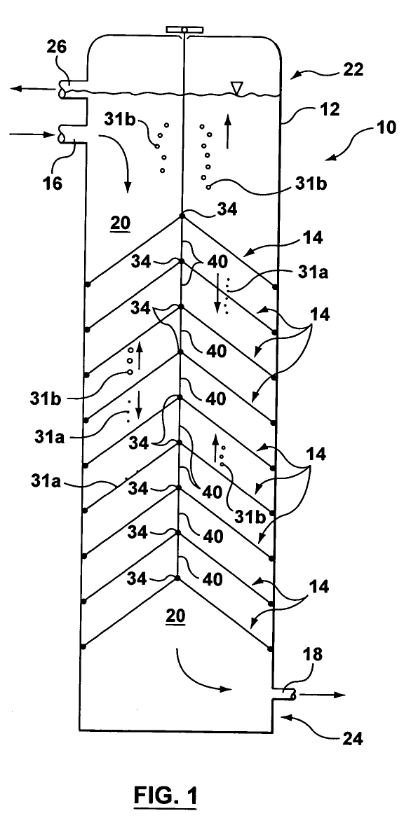

A degassing apparatus 10 according to the present invention for removing bubbles from a liquid is shown substantially in FIG. 1. The degassing apparatus 10 has a housing 12 and a plurality of bubble extraction elements 14 provided within the housing 12.

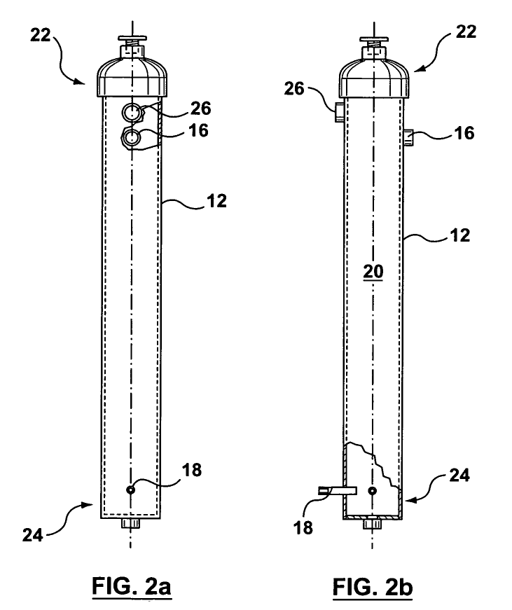

Referring now also to FIGS. 2a and 2b, the housing 12 has an upper inlet 16 and a lower outlet 18, and defines a flow channel 20 between the inlet 16 and outlet 18. In the embodiment illustrated, the housing 12 is generally cylindrical, having upper and lower ends 22, 24, respectively. The inlet 16 and outlet 18 can extend as ports from the sidewall of the housing 12 adjacent the upper and lower ends 22, 24, respectively. The housing 12 can also be provided with a vent 26 at an elevation above the inlet 16 to exhaust gases from a vented area at the top of the housing 102.

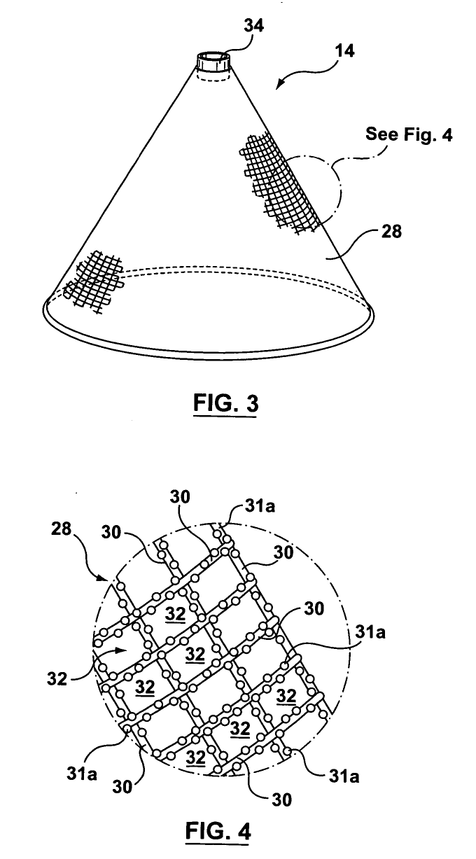

Referring now to FIGS. 1 and 3, the bubble extraction elements 14 are provided within the housing 12, spanning across the width of the housing 12 and intercepting the flow channel 20. The bubble extraction elements 14 are porous, and allow fluid to cross between upstream and downstream sides of the elements 14.

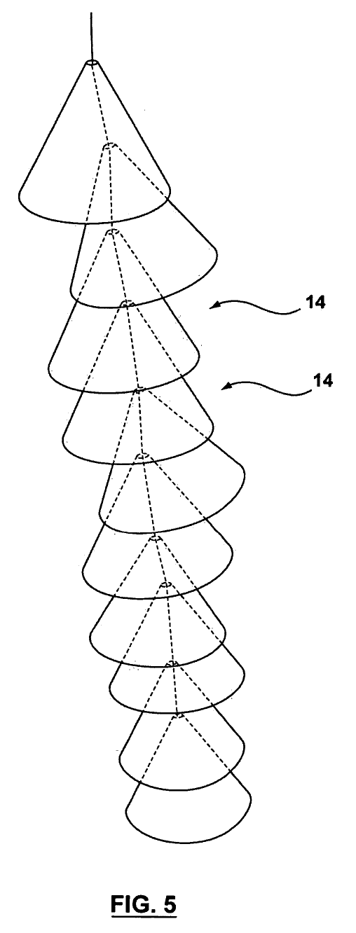

In the embodiment illustrated, the bubble extraction elements 14 include apertured sheet material 28 with an outer edge that is fitted snugly to their inside surfaces of the sidewalls of the housing 12. As best seen in FIG. 4, the apertured sheet material 28 can be a fabric or metal screen constructed of reticulating fibers 30 providing surfaces to which bubbles 31a can adhere, and defining apertures 32 between the fibers 30 through which liquid and bubbles can pass. The apertures 32 can have a size of, for example, but not limited to, about 1 mm×1 mm.

Furthermore, as in the embodiment illustrated, the sheet material 28 of the elements 14 can be formed into a conical shape, for reasons described more fully hereinafter. The elements 14 can have a grommet 34 at the apex of the sheet material 28, and a reinforcing hoop 36 can be provided along the circular base of the sheet material 28. The reinforcing hoop 36 can be in the form of a length of plastic tubing curved or bent into a loop and secured to the outer edge of the sheet 28. Alternatively, the reinforcing hoop 36 can be in the form of a curved or bent metallic strip.

The elements 14 of the embodiment illustrated are positioned within the housing 12 with their apecies directed upwards, or upstream with respect to the treatment channel 20. The reinforcing hoops 36 can provide a snug fit within the housing 12 to ensure that most or all of the liquid passing through the treatment channel 20 flows through (rather than around) the elements 14.

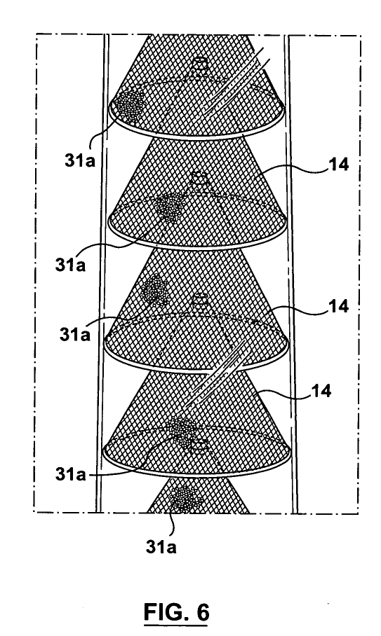

Referring to FIGS. 1 and 5, a plurality of elements 14 can be provided in series along the length of the treatment channel 20. In the embodiment illustrated, about eight to sixteen elements 14 are provided, having their apecies spaced apart by a short distance, for example, but without limitation, by about 1 to 10 cm, such that adjacent elements 14 are partially nested. The elements 14 can be connected by links 40 extending between the grommets 34 of adjacent elements 14. The links 40 can facilitate installation of the elements 14 into the housing 12, and can help to maintain a spaced relation between adjacent elements 14. In the embodiment illustrated, the links 40 comprise lengths of cord that extend a distance of about 2.5 cm between adjacent grommets 34.

In use, a liquid to be treated by the degassing apparatus 10 is fed into the intlet 16 and generally fills the treatment channel 20. An amount of treated liquid is drawn from the outlet 18, to be supplied to a downstream apparatus such as, for example, but not limited to, a particle counter, laser turbidmeter, or silt density index tester. The liquid can be supplied to the inlet 16 at a greater rate than the flow through the outlet 18, to ensure that a steady, constant supply of water is present in the degassing apparatus 10 and available for any downstream equipment. The excess rate of liquid supplied to the inlet 16 compared to that drained through the outlet 18 can exit, by overflow, through the apparatus 10 through the vent 26 and be sent to a drain or reintroduced to the process stream as appropriate. Alternately, a separate outlet for excess liquid may be provided. The surface of the liquid in the housing 12 can generally be held at a constant level that corresponds generally to the elevation of the vent 26.

The rate of liquid discharged through the outlet 18 is quite small in comparison to the volume of the treatment channel 20. For example, in the embodiment illustrated, the volume of the treatment channel 20 is about 5 litres, and the outlet flow is about 100 ml/min. Furthermore, the cross-sectional area of the outlet 18 is significantly less than the cross-sectional area of the treatment channel 20. In the embodiment illustrated, the area of the outlet 18 is about 1/25 the area of the treatment channel 20. As a result of this configuration, the downward flow of the liquid through the treatment channel 20 can be reduced to a rate that is generally less than the upward migration or flow of larger bubbles 31b, for example bubbles of 10-15 microns or more in diameter, entrained in the liquid. Such bubbles 31b move upwards against the flow of the liquid due to the buoyancy force of the air bubbles relative to the liquid.

The inventor has discovered that providing a slow flow rate of liquid through the treatment channel 20 alone will generally effectively remove only larger sized bubbles 31b. In particular, the inventor has found that smaller micro-bubbles 31a having a diameter of 1-15 microns or less are not removed by the reduced flow rate in the treatment channel 20 alone in sufficient quantity to allow accurate readings of membrane filtered permeate. Such smaller bubbles 31a can remain entrained in the liquid and discharged through the outlet 18.

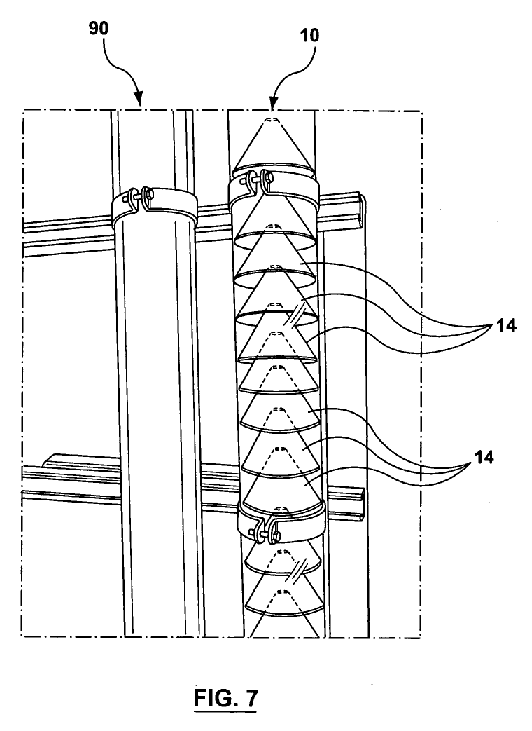

To increase the effectiveness of removal of the smaller bubbles 31a, the apparatus 10 is provided with the bubble extraction elements 14. In use, as the liquid with entrained bubbles 31a (and bubbles 31b) flows through the treatment channel 20, the liquid is directed to flow through the apertures 32 or pores in the bubble extraction elements 14. The small bubbles 31a can contact and adhere to the surface 30 of the elements 14, for example by surface tension effects. The fine size of the apertures 32 and the number of elements 14 in series through which the water successively flows increases the likelihood of contact between the small bubbles 31a and the surface 30 of the elements 14 by providing a large surface area for contact. As a result, when in use, the elements 14 are generally covered by a layer of bubbles 31a along the perpendicular fibers 30 (see FIG. 6).

As more and more bubbles 31a contact the fibers 30 or other previously adhered bubbles 31a, the bubbles 31a on the fibers 30 grow in size until eventually the buoyant force of the bubble 31a overcomes the surface tension force adhering the bubble 31a to the fibers 30. The downward force due to friction of the liquid around the bubble is generally proportional to the size (diameter) of the bubble 31a, while the upward buoyant force is generally proportional to the volume (diameter cubed) of the bubble 31a. Thus, as the bubble 31a grows in size, the upward force increases more than the downward force. When the upward force surpasses the downward force and any surface tension forces holding the bubble 31a to the material, the bubble 31a breaks free and becomes a larger, upward moving bubble 31b that can flow upwards through the apertures 32 of any upstream elements 14. Any larger, free bubbles 31b that come up against the underside of an upper element 14 can merge or coalesce with other adhered bubbles 31a on that element 14, until eventually the bubbles 31b reach the upper surface of the liquid in the housing 12. The bubbles 31b can burst at the surface, and the air (or other gas) is exhausted through the vent 26.

The inventor has found that under certain conditions, the bubbles 31a adhered to the fibers 30 of the sheet material 28 of the bubble extraction elements 14 can grow in size to a point where some of the apertures 32 become blocked by the air so that the liquid is prevented from flowing through such blocked apertures 32. Such blockage is generally temporary, since the bubbles 31a forming the blockage eventually grow to a sufficient size to break free from the element 14. However, if a sufficient number of apertures 32 become blocked at the same time, the treatment channel 20 can be sufficiently restricted such that an undesired reduction in flow rate can result. To reduce the chance of occurrence of such a condition, the elements 14 can be configured to bias the position across the treatment channel 20 at which the merged bubbles 31b tend to collect on, and break free from, the element 14. In particular, in the embodiment illustrated, each element 14 is cone-shaped with an upwardly directed apex. Merging bubbles 31b still generally adhered to the surface of the elements are urged towards the apex as they grow in size. Any trapped bubbles underneath an element 14 are also urged towards the central (or axial) portion of the channel 20 by the sloped underside, sloped for example by 20 degrees or more from horizontal, of the conical elements 14. This facilitates in maintaining an annular region of the elements 14 around the apecies of the elements 14 clear to conduct the downward flow of liquid through the treatment channel 20. Optionally, the grommet 34 may have an opening larger than the apertures 32 to facilitate discharge of bubbles from the underside of the elements 14. These openings could further optionally be connected to a tube extending vertically through the series of grommets 34. The tube would have openings in its sides near where the elements 14 contact the tube and have an open end above the water level, or vent 26, in the degassing apparatus 10. In this way, a dedicated channel, generally disconnected from the downward flow of water in the degassing apparatus 10, is provided for upward flow of larger bubbles 31b. However, the inventor has found that neither of these options are required for adequate operation.

In comparison to known degassers, using the apparatus 10 can remove more bubbles 31a, 31b from the liquid being treated, and particularly can remove more smaller sized bubbles 31a. The apparatus 10 can more effectively remove bubbles 31a at higher flow rates of liquid through a treatment channel 20, since the bubble extraction elements 14 promote merging of smaller bubbles 31a into larger bubbles 31b, which have a greater upward buoyant force and can therefore overcome a greater downward force that may be caused by higher flow rates.

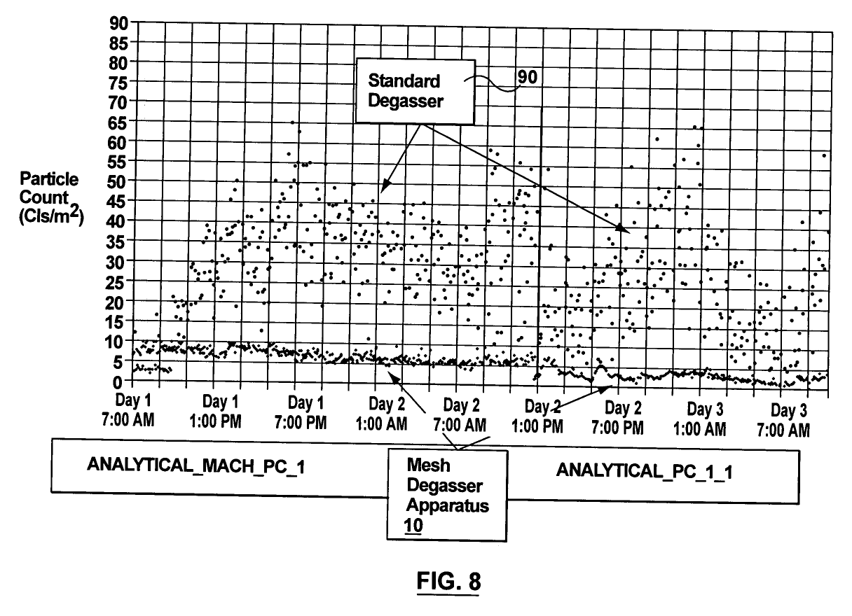

Referring to FIG. 7, a test was run using the degassing apparatus 10 and a known degasser 90 in parallel, each fed by the same permeate from a membrane filter having pores of about 0.3 microns, i.e. in the ultrafiltration or microfiltration range, each degasser feeding one of two separate particle counters. The known degasser 90 is a column degasser, having a cylindrical housing without any interior bubble extraction elements. The bubble extraction elements 14 are visible through the clear plastic housing 12 of the apparatus 10, while the column in the known degasser 90 contains only the treatment liquid.

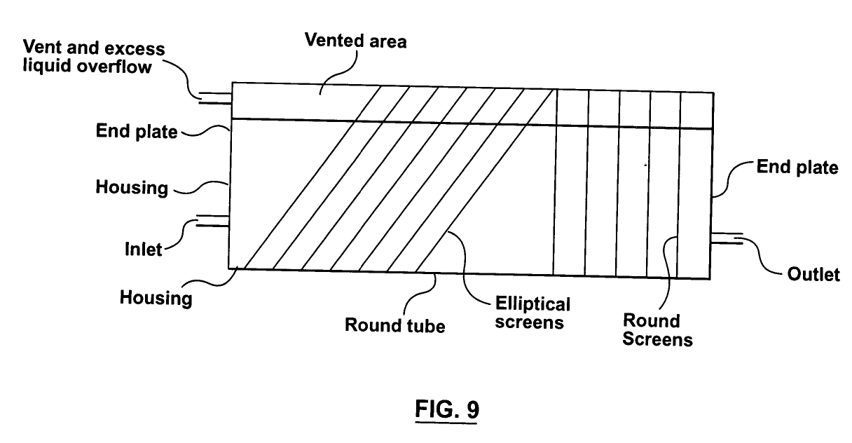

The results of the test can be seen in FIG. 8. The known degasser 90 registered particle counts generally within the range of 15 to 55 Cts/ml, and with peak readings as high as 65 Cts/ml or more. In contrast, the apparatus 10 registered particle counts in a narrow band of 0 to 10 Cts/ml with almost a total elimination of any data spikes or peaks.

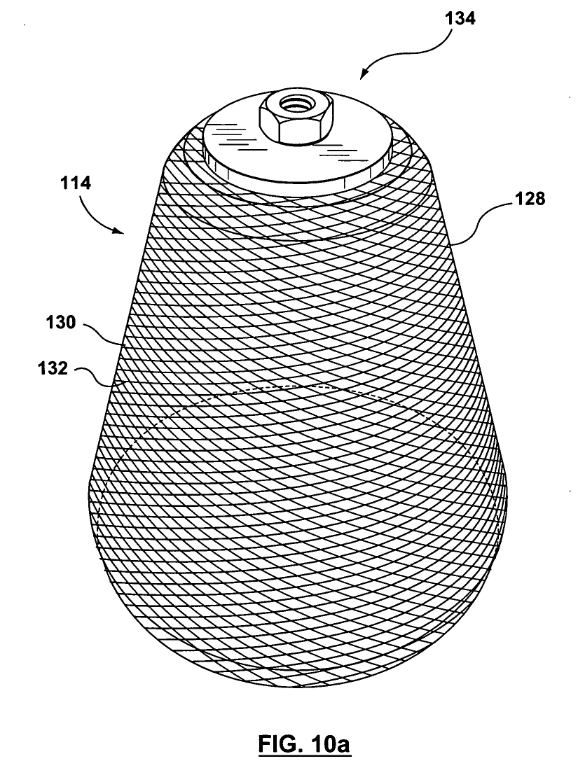

While preferred embodiments of the invention have been described herein in detail, it is to be understood that this description is by way of example only, and is not intended to be limiting. For example, but without limitation, modified embodiments, such as the one shown in FIG. 9, could be made in which the liquid flows horizontally and the bubbles rise partially vertically to a vented area oriented across an upper surface of the liquid, optionally extending from the inlet to the outlet. Other modified embodiments could have an open housing wherein the vent 26 is replaced by the open top of the device. Yet further optionally, the vent 26 does not need to allow a liquid overflow which may be deleted entirely or replaced by other means of removing excess liquid.

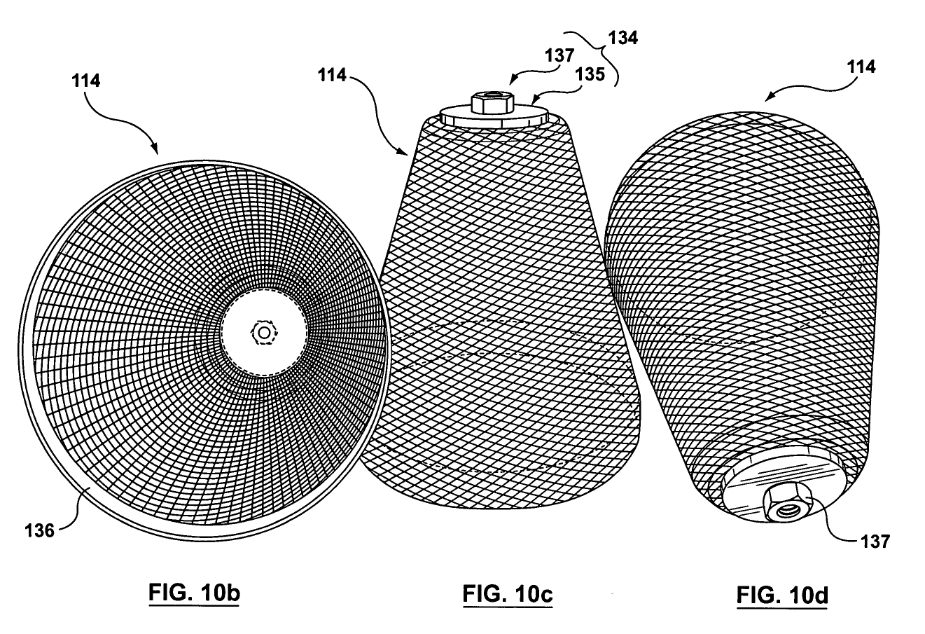

As another example, the bubble extraction elements can be in the form of an alternate embodiment identified generally at 114 in FIGS. 10a-10d. The bubble extraction element 114 is constructed of a generally conical metal screen 128. The metal screen 128 has interconnected metal strands 130 defining apertures 132 therebetween. A grommet 134 is provided at the upper end of the element 114. The grommet 134 has a plate portion 135 secured to an upper periphery of the metal screen 128, and a nut portion 137 secured centrally to the plate portion 135. A plurality of elements 114 can be connected or linked together in spaced apart relation by a length of threaded rod (not illustrated) engaged with and extending between the nut portions 137 of adjacent elements 114. The elements 114 can further include a reinforcing hoop 136 along the periphery of the base of the screen 128. The reinforcing hoop 136, in the embodiment illustrated, is in the form of a generally circular strip of bar of metal.

For further example, the elements 14 might not be apertured, but might be biosurface balls as used in biological filtration units or other structures that provide surface area for releasably holding bubbles while permitting the water to flow past the surfaces. Other embodiments or methods may also be made or used within the scope of the invention which is defined by the following claims.

1. A degassing apparatus for removing bubbles from a liquid, the apparatus comprising:
a) a housing having an inlet and an outlet displaced from the inlet, the housing defining a treatment channel between the inlet and outlet for liquid flow and a ventable area in connection with a vent above the treatment channel; and
b) one or more elements in the housing and extending across the treatment channel, the elements having contact surfaces past which a liquid flowing through the treatment channel can pass, and to which bubbles entrained in the liquid releasably adhere.

2. The apparatus of claim 1 wherein the element comprises a sheet of fibers forming apertures between the fibers.

3. The apparatus of claim 1 wherein the element is configured to bias adhered bubbles to concentrate in a portion of the element.

4. The apparatus of claim 1 wherein the housing is cylindrical and the elements are shaped into a cone with its apex directed towards the inlet.

5. A method for removing bubbles from a liquid, the method comprising conducting a liquid past an intercepting element, the element providing a surface, such that micro-bubbles entrained in the liquid releasably adhere to the surface until sufficient bubbles merge together with other adhered bubbles to form enlarged bubbles that ultimately break free from the surface and travel out of the liquid.
